(19) United States
(12) Patent Application Publication
(10) Pub. No.: US 2005/0152223 A1
(43) Pub. Date: Jul. 14, 2005

(54) Timekeeping apparatus

(76) Inventor: Tetsuji Kawakami, Tokyo (JP)

Correspondence Address: SNELL & WILMER LLP, 1920 MAIN STREET, SUITE 1200, IRVINE, CA, 92614-7230, US

(21) Appl. No.: 11/033,084

(22) Filed: Jan. 10, 2005

(30) Foreign Application Priority Data
Jan. 13, 2004 (JP) 2004-5588

(51) Int. Cl. G04B 47/00; G04C 21/00; G04C 23/00

(52) U.S. Cl. 368/12

(57) ABSTRACT

Disclosed herein is a timekeeping apparatus having a timekeeping function, the timekeeping apparatus comprising a wake-up function unit configured to conduct a predetermined wake-up operation at a preset time; and an additional functions unit configured to operate in association with the activation of the wake-up function unit.

### BACKGROUND OF THE INVENTION

1. Field of the Invention

The present invention relates to a timekeeping apparatus, and more particularly, to a timekeeping apparatus having not only the function of waking up a user at a wake-up time preset by the user, but also functions that work on the sleeping user at times other than the wake-up time.

2. Description of the Related Art

Conventionally, alarm clocks have consistently been configured to wake up a sleeping user, but a more multifunctional alarm clock has been proposed which includes not only the function of waking up the user but other functions as well (e.g., see Japanese Patent Application Laid-Open Publication No. 11-25752). In addition to a timekeeping function, this alarm clock includes an illumination device that not only illuminates the face of the timekeeping apparatus but wakes up the user with light together with a wake-up sound.

The problem that the present invention attempts to address is that conventional alarm clocks have consistently been configured with the purpose of waking up the sleeping user at a set wake-up time and have increased the means for achieving that purpose. Conventional alarm clocks have not been configured to act on the sleeping user at times other than the wake-up time or to pleasantly aid the sleep of the user.

### SUMMARY OF THE INVENTION

The present invention was conceived in order to address this problem and provides a timekeeping apparatus that is configured to act on a sleeping user from when the user activates the wake-up function to when the time reaches the wake-up time so that the user can experience a pleasant sleep, and which includes functions that aid the sleep of the user so that the user can experience dreams that the user wishes to experience.

A major aspect of the present invention provides a timekeeping apparatus having a timekeeping function, the timekeeping apparatus comprising a wake-up function unit configured to conduct a predetermined wake-up operation at a preset time; and an additional functions unit configured to operate in association with the activation of the wake-up function unit.

Preferably, the additional functions unit includes at least one of a light-emitting function unit, an aroma function unit and a sound production function unit, with the at least one function unit operating under predetermined time management after the activation of the wake-up function unit so that the functions can act on the user at times other than the wake-up time. The timekeeping apparatus may be arranged such that when a predetermined amount of time elapses after the wake-up function unit is activated, at least one of the aroma function unit and the sound production function unit operates for a set amount of time, and that the predetermined amount of time is a REM sleep time estimated on the basis of the preset wake-up time or a time estimated to overlap with the REM sleep time. Plural sound effects may be set in the sound production function unit such that a proper sound effect can be generated among the plural sound effects in accordance with conditions set in advance by the user. The sound production function unit may record the voice of the user and output the recorded voice during the predetermined amount of time such that the sleeping user can be acted on.

According to the major aspect of the present invention, not only is the operation of waking up the user at the preset wake-up time conducted, but the plural additional functions are also operated in association with the activation of the wake-up function. Thus, not only is the sleeping user simply woken up, but the additional functions work on the user while the user is sleeping, so that the timekeeping apparatus of the present invention is differentiated from alarm clocks that simply wake up the user.

The additional functions are configured by at least one of the light-emitting function, the aroma function and the sound production function, and all or one of the additional functions are operated by predetermined time management after the activation of the wake-up function. Thus, the functions work on the user at times other than the wake-up time, so that the user can experience a more pleasant sleep and a more pleasant wake-up. Preferably, the additional functions are configured by the light-emitting function, the aroma function and the sound production function, and all or one of the additional functions are operated by predetermined time management after the activation of the wake-up function. Thus, the functions work on the user at times other than the wake-up time, so that the user can experience a more pleasant sleep and a more pleasant wake-up. When the wake-up function is activated and the time reaches a time estimated to be a REM sleep time, at least one of the aroma function and the sound production function operates for a preset amount of time. Thus, the user can set an environment where the user is surrounded by the fragrance of aromas and pleasant sound effects and experiences dreams. The sound production function selects and generates appropriate sound effects in accordance with conditions preset by the user. Thus, the user can experience a pleasant sleep by listening to pleasant sound effects as the user is sleeping. The user records a message that the user wishes to hear during the REM sleep time, and when the time reaches the time thought to be the REM sleep time, the user hears the recorded message while the user is sleeping, whereby the user can more reliably set an environment where the user experiences dreams that the user wishes to experience.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a front perspective view showing an example of a timekeeping apparatus in accordance with the present invention;

FIG. 2 is a rear perspective view of the timekeeping apparatus;

FIG. 3 is a block diagram describing the electrical configuration of the timekeeping apparatus;

FIG. 4 is a flow chart describing operating modes of the timekeeping apparatus;

FIGS. 5A to 5C are time charts describing the operating modes of the timekeeping apparatus; and

FIG. 6 is a perspective view describing another potential use of the timekeeping apparatus.

### DESCRIPTION OF THE PREFERRED EMBODIMENT

A timekeeping apparatus in accordance with the present invention includes a timekeeping function and a wake-up function that conducts a predetermined wake-up operation at a preset time. In addition to the wake-up function, the timekeeping apparatus includes other additional functions. The additional functions are configured to work on the user after the wake-up function is activated until the wake-up time.

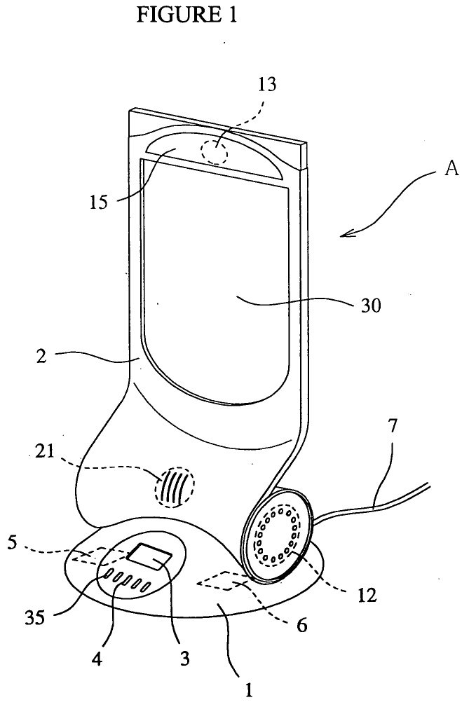

FIG. 1 shows an example of a timekeeping apparatus A in accordance with the present invention. The timekeeping apparatus A is configured by a display panel 2 vertically disposed on an upper surface of a substantially discoid base 1, so that overall the timekeeping apparatus A is formed in a substantial inverted “T” shape when seen in a side view.

A display unit 3 that displays the time and guide messages and an operation unit 4 for setting a wake-up time and modes are disposed on a front surface of the base 1. A timekeeping function unit 5 and a control unit 6 that controls the entire timekeeping apparatus A are disposed inside the base 1. The control unit 6 activates and controls one or all of plural (three in the present embodiment) additional functions in accordance with the wake-up time set by the operation unit 4 and the sleeping state of the user.

Here it is assumed that the timekeeping apparatus A operates on power from a battery, but as shown in FIG. 1, a power unit may also be disposed inside the timekeeping apparatus A so that the timekeeping apparatus A is supplied with household electrical power using a power cable 7.

It is known that people have two sleeping states: one is a deep state of sleep usually called non-REM sleep, and the other is a light state of sleep usually called REM sleep. These two sleeping states periodically alternate and repeat. When the sleeper is forcibly woken up during non-REM sleep, there is the potential for the sleeper to experience an unpleasant wake-up, and when the sleeper wakes up during REM sleep, the sleeper can experience a pleasant wake-up.

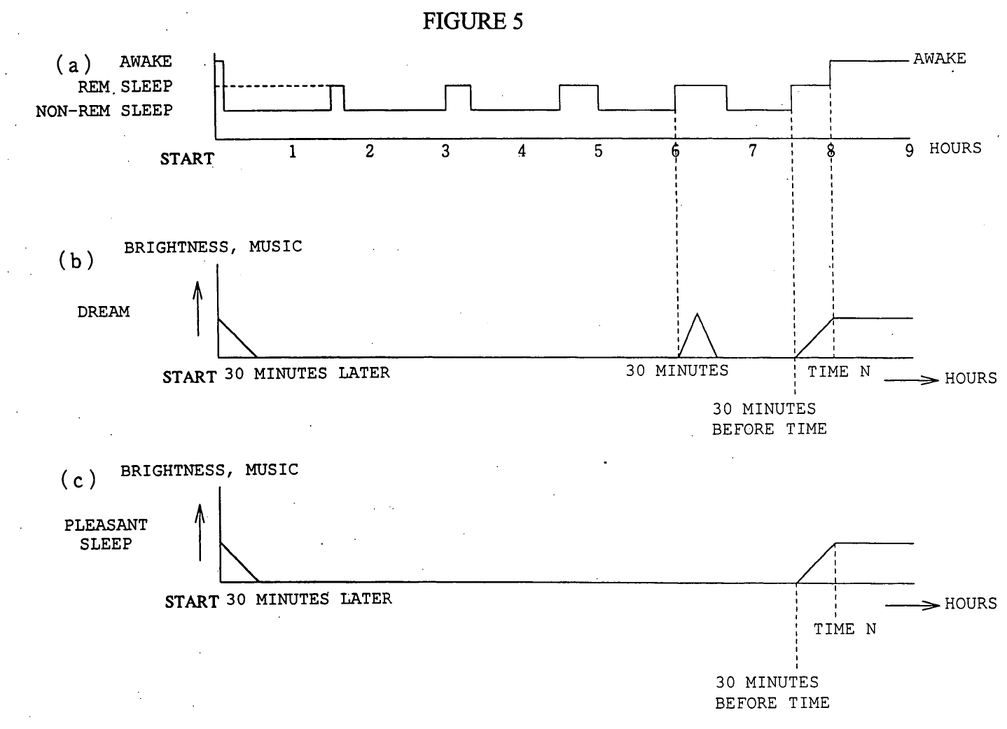

Non-REM sleep continues for about an hour and a half after a person falls asleep, and REM sleep occurs thereafter. Then, REM sleep and non-REM sleep repeat in 90-minute cycles. The first REM sleep cycle lasts for about 10 minutes, and thereafter the cycles of REM sleep gradually become longer, so that the fourth cycle lasts for about 40 minutes (see FIG. 5A).

People experience dreams during sleep, and it is said that the majority of dreams people experience occur during REM sleep. When people experience dreams during REM sleep, which is closest to the time that people wake up, and have a pleasant wake-up experience, the potential for people to remember those dreams is higher.

In the present invention, the aforementioned additional functions are configured by a light-emitting function unit 10 that serves as a light, an aroma function unit 11 that emits fragrances of aromas, and a sound production function unit 12 that outputs sounds effects such as birdsong.

The light-emitting function unit 10 is disposed on an upper portion of the display panel 2, and is configured by an incandescent lamp 13, whose illumination intensity can be changed by changing the voltage, and a dimming circuit 14. The incandescent lamp 13 is disposed at an inner side of a translucent panel 15 disposed on the upper portion of the display panel 2. The incandescent lamp 13 is configured to cause the panel 15 to be brightly lit when the incandescent lamp 13 is turned ON. The incandescent lamp 13 is also controlled by the dimming circuit 14 to gradually light up or gradually go out over a predetermined period of time (in the present embodiment, this time is set to be 30 minutes).

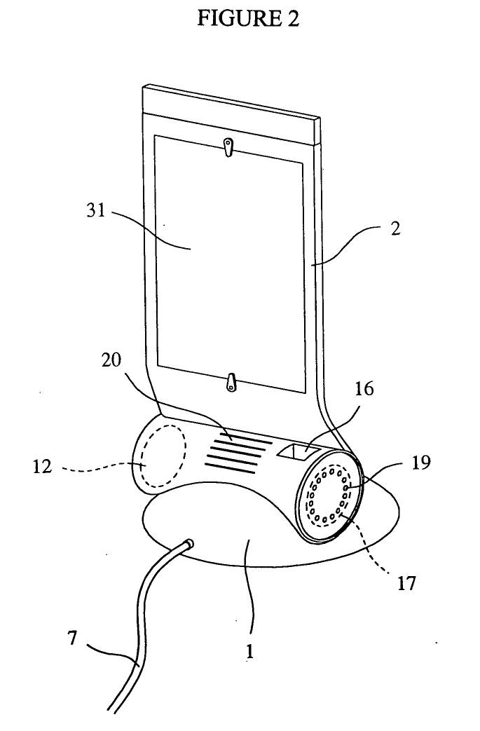

The aroma function unit 11 is configured by a fan 17 and a driver 18 for discharging fragrances of aromatic substances that emit fragrances having a relaxation effect, such as “lavender” and “citrus”. The aromatic substances are disposed in a housing unit 16 formed in the upper portion of the base 1. The fan 17 is configured to operate only for a predetermined period of time at a later-described time slot and to exhale the fragrances through small holes 19 in a left side surface of the timekeeping apparatus A (see FIG. 2).

In FIG. 2, reference numeral 20 indicates slits for taking in air. Air taken in through the slits as a result of the fan 17 rotating picks up the fragrances of the aromatic substances and is exhaled through the small holes 19 for blowing out the air.

The sound production function unit 12 is configured by a microphone 21 for inputting a user's voice, a memory 22 for storing the voice inputted by the microphone 21 as voice data, a memory 23 in which sound effects data such as different kinds of music and birdsong are already stored, and an amplifier 25 for converting the voice data and sound effects data stored in the memories 22 and 23 into audio signals and causing the audio signals to be outputted from a speaker 24. The time at which output of the voice data and the sound effects data begins, and how long the voice data and sound effects data are outputted, are controlled by the control unit 6.

In the present embodiment, the timekeeping apparatus A is disposed with a visual effects function unit 30 in addition to the additional functions unit. The visual effects function unit 30 may be configured by a photograph stand adorned with a display item in which the subject of a dream that the user wants to experience is displayed (e.g., a photograph of someone for whom the user longs, etc.). The visual effects function unit 30 is disposed in the display panel 2. The front surface of the display panel 2 is formed by a window portion made of transparent glass or acrylic resin. The user can place a favorite photograph in the visual effects function unit 30 by opening a rear cover 31 (see FIG. 2).

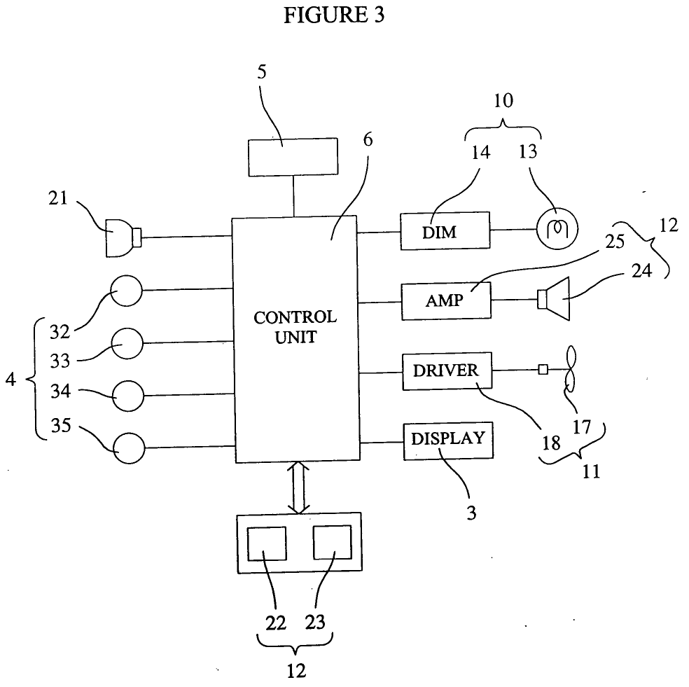

FIG. 3 is a block diagram describing the electrical configuration of the timekeeping apparatus A. Reference numeral 3 indicates the display unit that displays the time and the various kinds of guide messages at the time of setting. The display unit 3 may be configured by a known liquid crystal display.

Reference numeral 24 indicates the control unit that controls the entire timekeeping apparatus A, reference numeral 25 indicates the amplifier that amplifies the audio signals, reference numeral 18 indicates the driver that drives the fan 17, and reference numeral 14 indicates the dimming circuit that controls the incandescent lamp 13.

Reference numerals 32 to 34 indicate operational buttons for conducting various kinds of settings, such as the setting of the wake-up time.

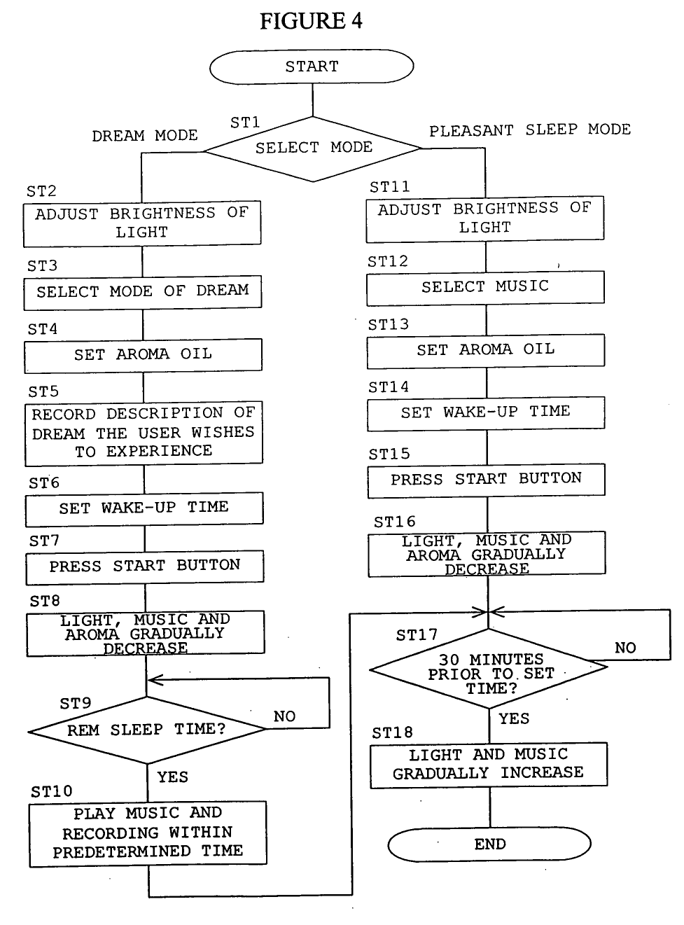

Next, the use modes of the timekeeping apparatus A having the above configuration will be described on the basis of the flow chart of FIG. 4 and the time charts of FIGS. 5A to 5C.

When the power is turned ON, the current time is displayed on the display unit 3 in the same manner as an ordinary alarm clock. If the displayed time is not correct, the user may adjust the time with an operational button. When the user uses the timekeeping apparatus as an alarm clock, the user may select a mode in step ST1. The modes here include a dream mode and a pleasant sleep mode. The dream mode is a mode that creates an environment which induces and aids a user to have a dream that the user wishes to experience. The pleasant sleep mode is a mode that creates an environment which allows the user to enter a pleasant sleep and comfortably wake up at the set wake-up time.

When the process proceeds to step ST2, the brightness of the light 13 when the user is to awake is set. When the user finishes setting the brightness of the light 13, modes of dreams (e.g., “love”, “work”, etc.) are displayed on the display unit 3 and the user selects the mode of dream that the user wishes to experience (e.g., “love”) (step ST3). Music and sound effects are set for each mode, so that when the mode is set, the set music and sound effects are outputted as background music when the wake-up function begins (when the user goes to bed).

Next, the user sets aroma oil in the housing unit 16 (step ST4) and the process proceeds to step ST5, where the user records a message or thought relating to the dream that the user wishes to experience (e.g., “I would love to go out with person A”, etc.).

Next, in step ST6, the user sets the time at which the user wishes to wake up (wake-up time) and presses an alarm button 35 (step ST7).

When the alarm button 35 is pressed, the wake-up function unit is activated. As shown in FIG. 5B, the brightness of the incandescent lamp 13, which is currently ON, gradually becomes dimmer until the incandescent lamp 13 goes out after 30 minutes. In accompaniment therewith, the music outputted from the speaker 24 fades out over a 30-minute period, and the fan 17 discharging the fragrance of the aroma stops after 30 minutes. Thus, as the room gradually becomes darker, the music and sound effects of the mode set in step ST3 gradually fade out until they finally stop, so that the user is able to enter a restful sleep (step ST8).

The user enters a sleeping state and the REM sleep time is set. The control unit 6 estimates the REM sleep time slot closest to the wake-up time from the time when the alarm button 35 was pressed, and sets the time estimated to overlap with this time slot as the REM sleep time. As described above, the potential for a person to best remember the dream experienced by that person is greatest at the REM sleep time slot closest to when the person wakes up. Thus, the control unit 6 is configured to estimate that time, but the control unit 6 may also be configured to estimate another REM sleep time slot during the sleeping time and set that other REM sleep time as the REM sleep-time.

As shown in FIG. 5A, when the wake-up time is set to be after 8 hours, the REM sleep time estimated to occur after 6 hours is determined as the REM sleep time (step ST9). As shown in FIG. 5B, the sound effects (background music) of the mode set in step ST3 increase over a predetermined amount of time (in the present embodiment, this time is set to 30 minutes), and the voice that had been recorded in advance (e.g., “I would love to go out with person A”) is repeatedly outputted from the speaker 24 so as to be whispered near the ears of the user (step ST10).

Because the user is repeatedly made to hear the user's desires while the user is in a light sleep, the potential increases for the user to experience, before the user knows it, a dream in which the user is going out with person A.

Then, when the time reaches 30 minutes prior to the wake-up time (step ST17), the process proceeds to step ST18, where the brightness of the incandescent lamp 13 is gradually raised, so that 30 minutes later the incandescent lamp 13 is shining at the brightness set in step ST2. In accompaniment therewith, the sound effects (e.g., the chirping of small birds) outputted from the speaker 24 increase, whereby the room gradually becomes brighter, visual stimulation is gradually given to the user when the user wakes up, and the sound effects gradually become louder. Thus, the user is gradually woken up by stimulation in terms of both visual stimulation and aural stimulation. In contrast to the case of a conventional alarm clock that suddenly outputs an alarm sound or the like, the timekeeping apparatus A of the present invention allows the user to wake up peacefully without the user being suddenly woken up and without the dream induced by the repeatedly heard voice during the REM sleep time disappearing.

When the time reaches the set wake-up time, finally the wake-up operation is executed where an alarm sound is outputted from the speaker 24 in the same manner as a conventional alarm clock; however, the timekeeping apparatus A may also be configured so that whether or not an alarm sound is to be outputted is separately set at the time the user sets the wake-up time in step ST6.

When the user has selected the pleasant sleep mode in step ST1, the process proceeds to step ST11, where the brightness of the incandescent lamp 13 when the user is to awake is set. When the user finishes setting the brightness of the incandescent lamp 13, the user selects the music that the user wishes to hear when the user goes to bed and wakes up (step ST12).

Next, the user places aroma oil in the housing unit 16 (step ST13) In step ST14, the user sets the time at which the user wants to wake up (wake-up time), and in step ST15, the user presses the alarm button 35.

When the alarm button 35 is pressed, the wake-up function is activated. As shown in FIG. 5C, the brightness of the incandescent lamp 13, which is currently ON, gradually becomes dimmer until the incandescent lamp 13 goes out after 30 minutes. In accompaniment therewith, the music outputted from the speaker 24 fades out over a 30-minute period, and the fan 17 discharging the fragrance of the aroma stops after 30 minutes. Thus, as the room gradually becomes darker, the music gradually becomes quieter until it finally stops, so that an environment is created where the user is able to enter a restful sleep (step ST16).

Then, when the time reaches 30 minutes prior to the wake-up time (step ST17), the process proceeds to step ST18, where the brightness of the incandescent lamp 13 is gradually raised, so that 30 minutes later the incandescent lamp 13 is shining at the brightness set in step ST11. In accompaniment therewith, the sound effects (e.g., the chirping of small birds) outputted from the speaker 24 increase, whereby the room gradually becomes brighter, visual stimulation is gradually given to the user when the user wakes up, and the sound effects gradually become louder. Thus, the user is gradually woken up by stimulation in terms of both visual stimulation and aural stimulation. In contrast to the case of a conventional alarm clock that suddenly outputs an alarm sound or the like, the timekeeping apparatus A of the present invention allows the user to wake up peacefully without the user being suddenly woken up.

In the case of the pleasant sleep mode also, the wake-up operation is executed when an alarm sound is outputted from the speaker 24 at the wake-up time in the same manner as a conventional alarm clock; however, the timekeeping apparatus A may also be configured so that whether or not an alarm sound is to be outputted is separately set at the time the user sets the wake-up time in step ST14.

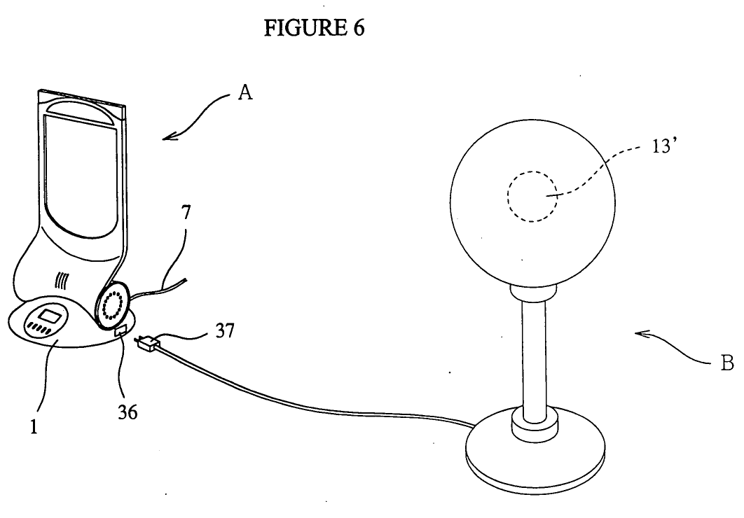

It will be noted that it is difficult to brighten the user's entire room with only the incandescent lamp 13 disposed in the display panel 2. Thus, as shown in FIG. 6, the base 1 may include an outlet 36 that is connected in parallel with the incandescent lamp 13 and is for connecting an illumination device B, such as a common electrical stand, using an incandescent lamp 13′. A plug 37 of a power cable of the illumination device B may be plugged into the outlet 36, so that the incandescent lamp 13′ gradually goes out as a result of the brightness thereof being lowered or gradually shines more brightly as a result of the brightness thereof being raised. In this case, the incandescent lamp 13 and the incandescent lamp 13′ of the illumination device B may operate on household electrical power, and the timekeeping apparatus A may include a power circuit for converting the alternating current of the household electricity to a direct current for running the internal circuits of the timekeeping apparatus A, so that electrical power is supplied via the power cable 7.

While the illustrative and presently preferred embodiment of the present invention has been described in detail herein, it is to be understood that the inventive concepts may be otherwise variously embodied and employed and that the appended claims are intended to be construed to include such variations except insofar as limited by the prior art.

1. A timekeeping apparatus having a timekeeping function, the timekeeping apparatus comprising:
a wake-up function unit configured to conduct a predetermined wake-up operation at a preset time; and
an additional functions unit configured to operate in association with the activation of the wake-up function unit.

2. The timekeeping apparatus of claim 1, wherein the additional functions unit includes at least one of a light-emitting function unit, an aroma function unit and a sound production function unit, with the at least one function unit operating under predetermined time management after the activation of the wake-up function unit.

3. The timekeeping apparatus of claim 1, wherein the additional functions unit includes a light-emitting function unit, an aroma function unit and a sound production function unit, with at least one of the function units operating under predetermined time management after the activation of the wake-up function unit.

4. The timekeeping apparatus of claim 2, wherein
when a predetermined amount of time elapses after the wake-up function unit is activated, at least one of the additional functions units operates for a set amount of time, and wherein
the predetermined amount of time is a REM sleep time estimated on the basis of the preset wake-up time or a time estimated to overlap with the REM sleep time.

5. The timekeeping apparatus of claim 3, wherein
when a predetermined amount of time elapses after the wake-up function unit is activated, at least one of the additional functions units operates for a set amount of time, and wherein
the predetermined amount of time is a REM sleep time estimated on the basis of the preset wake-up time or a time estimated to overlap with the REM sleep time.

6. The timekeeping apparatus of claim 5, wherein plural sound effects are set in the sound production function unit, and wherein the sound production function unit generates appropriate sound effects in accordance with preset conditions.

7. The timekeeping apparatus of claim 6, wherein the sound production function unit records the voice of a user and outputs the recorded voice during the predetermined amount of time.

8. In an alarm clock for providing indica of time and a capability of causing the user at a pre-set time period to wake, the improvement comprising;
a time management unit to determine a REM-related alarm clock time period from a user input into the alarm clock that can be operatively related to a REM sleep period, for the user.

9. The alarm clock of claim 8 wherein the user input is the pre-set wake-up time period for waking the user.

10. The alarm clock of claim 8 further including a light-emitting function unit, an aroma function unit and a round production function unit.

11. The alarm clock of claim 10 further including a REM function control unit that responds to the determined REM-related alarm clock time period to provide one of a light-emitting procedure, an aroma function and a sound production function.

12. The alarm clock of claim 11 wherein the sound production function unit includes a microphone and a memory unit to enable storage of voice data by the user.

13. The alarm clock of claim 11 wherein the light-emitting function unit, aroma function unit and sound production function unit are controlled by a central unit that initially activates related function units for a predetermined time period to facilitate the user to fall asleep.

14. The alarm clock of claim 13 further including a terminal plug outlet to permit a separate lamp unit to also be controlled by the control unit.

15. A timekeeping apparatus having a timekeeping function, the timekeeping apparatus comprising:
a wake-up function unit configured to conduct a predetermined wake-up operation at a preset time;
an additional functions unit configured to operate in association with the activation of the wake-up function unit for at least one time period associated with a REM sleep cycle of the user; and
a control unit for activating the additional functions unit.

16. The timekeeping apparatus of claim 15, wherein the additional functions unit includes at least one of a light-emitting function unit, an aroma function unit and a sound production function unit, with the at least one function unit operating under predetermined time management from the control unit after the user activation of the wake-up function unit.

17. The timekeeping apparatus of claim 15, wherein the additional functions unit includes a light-emitting function unit, an aroma function unit and a sound production function unit, with at least one of the function units operating under predetermined time management from the control unit after the user activation of the wake-up function unit.

18. The timekeeping apparatus of claim 16, wherein
when a predetermined amount of time elapses after the wake-up function unit is activated by the control unit, at least one of the additional functions units operates for a set amount of time, and wherein
the predetermined amount of time is a REM sleep time estimated on the basis of the preset wake-up time or a time estimated to overlap with the REM sleep time.

19. The timekeeping apparatus of claim 17, wherein
when a predetermined amount of time elapses after the wake-up function unit is activated by the control unit, at least one of the additional functions units operates for a set amount of time, and wherein
the predetermined amount of time is a REM sleep time estimated on the basis of the preset wake-up time or a time estimated to overlap with the REM sleep time.

20. The timekeeping apparatus of claim 17, wherein plural sound effects are stored in the sound production function unit, and wherein the sound production function unit generates appropriate sound effects in accordance with preset conditions.
